(19) United States
(12) Patent Application Publication
(10) Pub. No.: US 2020/0400258 A1
(43) Pub. Date: Dec. 24, 2020

(54) HOSE CONNECTOR REPAIRING DEVICE

(71) Applicant: Henry C. Chu, Orange, CA (US)

(72) Inventor: Henry C. Chu, Orange, CA (US)

(21) Appl. No.: 16/448,027

(22) Filed: Jun. 21, 2019

(51) Int. Cl. F16L 37/04; F16L 33/30

(52) U.S. Cl. CPC F16L 37/04; F16L 33/30

(57) ABSTRACT

A hose connector repairing device includes two hose members, a vehicle part having two connecting segments, two hose connector repairing element each having one section and having a chamber for engaging with the connecting segment of the vehicle part, and the hose connector repairing elements each include another section for engaging with the hose members, and a tubular member is engaged into the other section of the hose connector repairing element for reinforcing the other section of the hose connector repairing elements and for allowing the hose connector repairing elements to be solidly and stably secured in the hose members and for preventing the hose connector repairing elements and the hose members from being squeezed and collapsed.

### BACKGROUND OF THE INVENTION

### 1. Field of the Invention

The present invention relates to a hose connector device for various parts or elements of vehicles, and more particularly to a hose connector repairing device including an improved and simplified structure or configuration for allowing the hoses or pipes that connect or couple the parts or elements of the vehicles to be easily and quickly replaced or changed with the new parts or elements without removing the whole hoses or pipes.

### 2. Description of the Prior Art

Typically, vehicles comprise various kinds of hoses or piping systems have been developed and provided for receiving or engaging with oil, fuel, hydraulic oil, air or the like and for circulating the oil, the fuel, the hydraulic oil, the air or the like through the hoses or pipes, and various kinds of parts or elements are engaged with the hoses or pipes for allowing the oil, the fuel, the hydraulic oil, the air or the like to also flow through the hoses or pipes.

For example, the vehicles may comprise a number of parts or elements, such as pressure sensors, switches, inline filters, check valves, or the like provided and engaged in the hoses or pipes of the hydraulic oil systems, the fuel piping systems, the brake oil systems, the air conditioning systems or the like. After use, some of the parts or elements may be damaged and required to be changed or replaced with the new parts or elements, but the whole hoses or piping systems are required to be removed or replaced with the new hoses or piping systems even when only one of the parts or elements are damaged or become failed.

U.S. Pat. No. 6,409,225 discloses one of the typical hose-connector assemblies used for fuel transportation or other purposes in automotive vehicles, and the typical hose-connector assembly may include a hose with an outer protector tube and a connector.

However, when a number of parts or elements are engaged in the hoses or pipes of the typical hose-connector assemblies, the whole hoses or piping systems are also required to be removed or replaced with the new hoses or piping systems even when only one of the parts or elements are damaged or become failed.

For example, as shown in FIG. 5, a vehicle part or element 92, such as a pressure sensor 92, check valve or the like is connected or coupled between two hoses or pipes 90, 91, the whole hoses or pipes 90, 91 and the element 92 are all required to be removed or replaced with the new ones when the element 92 is damaged or become failed. Both the pipes 90, 91 are required to be cut off for removing the element 92 from the pipes 90, 91, but the pipes 90, 91 will be cut and become shorter after the element 92 has been cut and removed from the pipes 90, 91, such that the other new element will be difficult to be connected or coupled between the pipes 90, 91 again with the cut pipes 90, 91, and such that the pipes 90, 91 are also required to be removed or replaced with the new pipes.

The present invention has arisen to mitigate and/or obviate the afore-described disadvantages of the conventional hose connector devices.

### SUMMARY OF THE INVENTION

The primary objective of the present invention is to provide a hose connector repairing device including an improved and simplified structure or configuration for allowing the hoses or pipes that connect or couple the parts or elements of the vehicles to be easily and quickly replaced or changed with the new parts or elements without removing the whole hoses or pipes.

In accordance with one aspect of the invention, there is provided a hose connector repairing device comprising a first hose member, a second hose member, a vehicle part including a first connecting segment and a second connecting segment, a first hose connector repairing element including a first section having a chamber formed in the first section for engaging with the first connecting segment of the vehicle part, and the first hose connector repairing element including a second section for engaging with the first hose member, the second section of the first hose connector repairing element including a compartment formed in the second section of the first hose connector repairing element, a first tubular member engaged into the compartment of the second section of the first hose connector repairing element for reinforcing the second section of the first hose connector repairing element, a second hose connector repairing element including a first section having a chamber formed in the first section of the second hose connector repairing element for engaging with the second connecting segment of the vehicle part, and the second hose connector repairing element including a second section for engaging with the second hose member, the second section of the second hose connector repairing element including a compartment formed in the second section of the second hose connector repairing element, and a second tubular member engaged into the compartment of the second section of the second hose connector repairing element for reinforcing the second section of the second hose connector repairing element.

The first section of the first hose connector repairing element includes an outer diameter no less than that of the second section of the first hose connector repairing element, and the chamber of the first section of the first hose connector repairing element is communicating with the compartment of the second section of the first hose connector repairing element.

The first section of the second hose connector repairing element includes an outer diameter no less than that of the second section of the second hose connector repairing element, and the chamber of the first section of the second hose connector repairing element is communicating with the compartment of the second section of the second hose connector repairing element.

The first and the second connecting segments of the vehicle part are made of relatively harder materials, and the first sections of the first and the second hose connector repairing elements are made of relatively softer materials.

The first and the second tubular members are made of relatively harder materials, and the first and the second hose members are made of relatively softer materials.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a hose connector repairing device in accordance with the present invention;

FIG. 2 is another partial exploded view of the hose connector repairing device;

FIG. 3 is a cross sectional view of the hose connector repairing device;

FIG. 4 is another cross sectional view similar to FIG. 3, illustrating the operation of the hose connector repairing device; and

FIG. 5 is a perspective view illustrating one of the typical hose connectors.

### DETAILED DESCRIPTION OF THE PREFERRED EMBODIMENT

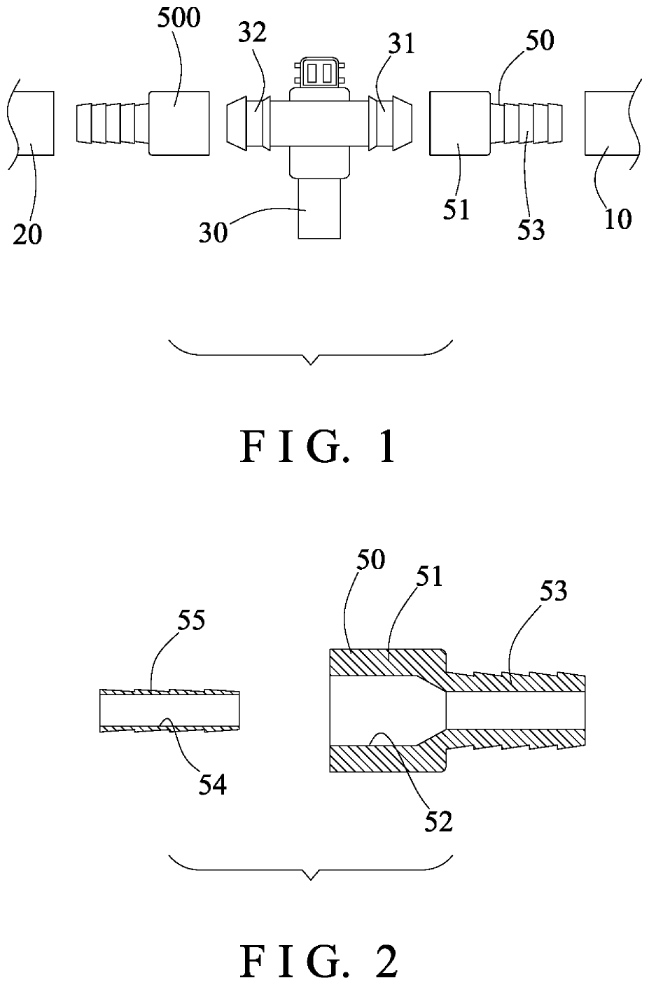

Referring to the drawings, and initially to FIGS. 1-3, a hose connector repairing device in accordance with the present invention comprises a first hose end or member 10, a second hose end or member 20, and a part or element 30 of a vehicle to be attached or mounted or secured or engaged to the hose members 10, 20 and engaged between the hose members 10, 20 with a first and a second hose connector repairing elements 50, 500 (FIG. 1). The part 30 of the vehicle may be selected from a pressure sensor 30, a switch, an inline filter, a check valve, or the like which includes two or first and second extensions or mouths or connecting segments 31, 32 formed or provided thereon for connecting or coupling to the hose members 10, 20 with the hose connector repairing elements 50 respectively.

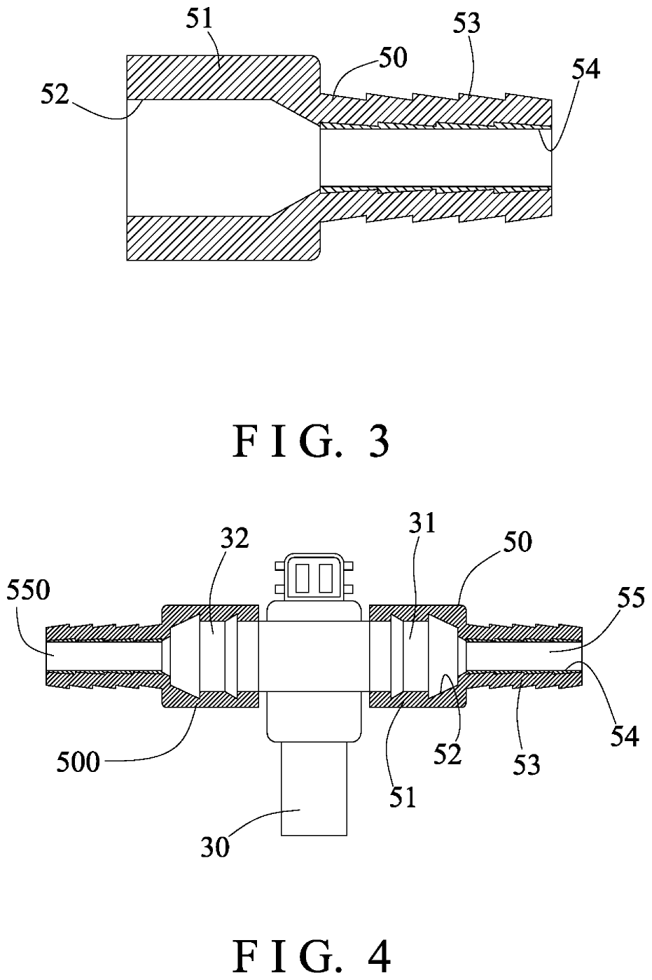

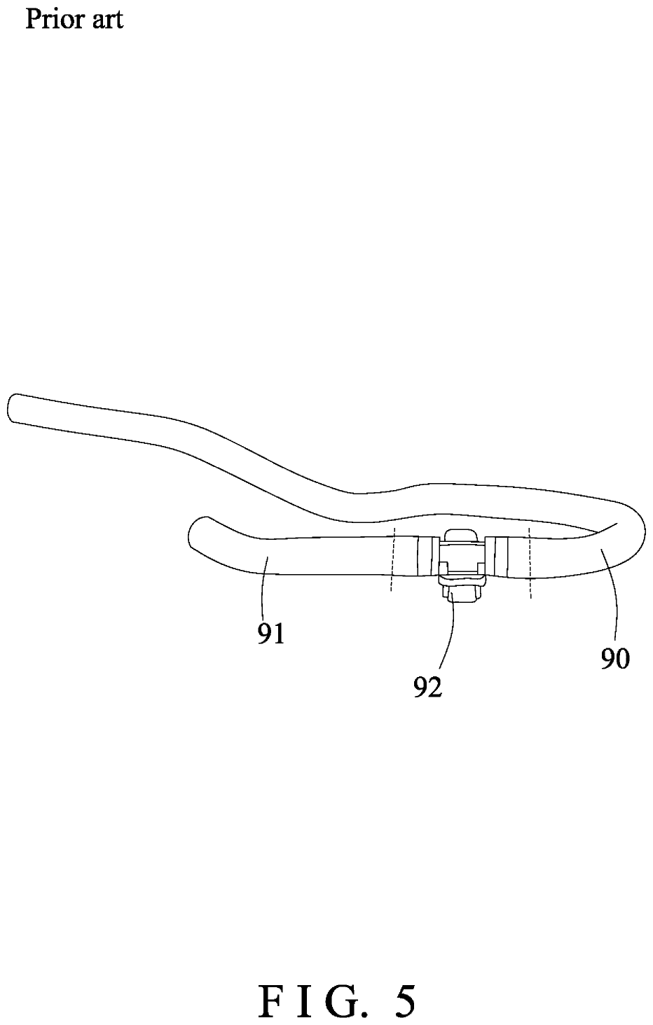

As shown in FIGS. 2 and 3, the hose connector repairing element 50 includes a first segment or section 51 having a compartment or chamber 52 formed therein for receiving or engaging with either of the connecting segments 31, 32 of the part 30 of the vehicle (FIG. 4). The vehicle part 30, particularly, the connecting segments 31, 32 of the part 30 of the vehicle are made of relatively harder materials, such as the composite materials, rubber or plastic materials, metal materials or the like, and the first section 51 of the hose connector repairing element 50 is made of relatively softer materials, such as the composite materials, rubber or plastic materials or the like for allowing the connecting segments 31, 32 of the part 30 of the vehicle to be solidly and stably and snugly fitted and engaged and secured in the first section 51 of the hose connector repairing element 50.

The hose connector repairing element 50 includes a second segment or section 53 having a chamber or compartment 54 formed therein for receiving or engaging with either of the hose members 10, 20, in which the second section 53 of the hose connector repairing element 50 may be made of relatively harder or softer materials, such as the composite materials, rubber or plastic materials or the like, and the hose members 10, 20 are also made of relatively softer materials, such as the composite materials, rubber or plastic materials or the like. It is preferable, but not necessary that the first section 51 of the hose connector repairing element 50 includes an outer diameter greater or no less than that of the second section 53 of the hose connector repairing element 50, and the chamber 52 of the first section 51 is communicating with the compartment 54 of the second section 53 and includes an inner diameter greater or no less than that of the second section 53.

The hose connector repairing element 50 further includes one or more (such as two) barrels or tubular members 55 engaged into the compartments 54 of the second sections 53 of the two hose connector repairing elements 50 respectively and made of relatively harder materials, such as the composite materials, rubber or plastic materials, metal materials or the like, for reinforcing the second section 53 of the hose connector repairing element 50 and for allowing the second section 53 of the hose connector repairing element 50 to be solidly and stably and snugly fitted and engaged and secured in either of the hose members 10, 20, and for preventing the second section 53 of the hose connector repairing element 50 and the hose member 10, 20 from being squeezed and collapsed.

In operation, as shown in FIG. 1, when one of the elements or vehicle parts 30 is damaged or become failed, the damaged vehicle part 30 may be cut from the hose members 10, 20, and the hose members 10, 20 may be spaced or separated from each other for a distance. The new vehicle part 30 may then have its the connecting segments 31, 32 engaged into or with the first sections 51 of the hose connector repairing elements 50, and the second sections 53 of the hose connector repairing elements 50 may then be engaged into or with the hose member 10, 20, and thus for allowing the damaged vehicle part 30 to be easily and quickly replaced or changed with the new vehicle part 30 without removing the whole hose members 10, 20.

Accordingly, the hose connector repairing device in accordance with the present invention includes an improved and simplified structure or configuration for allowing the hoses or pipes that connect or couple the parts or elements of the vehicles to be easily and quickly replaced or changed with the new parts or elements without removing the whole hoses or pipes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hose connector repairing device comprising:
a first hose member,
a second hose member,
a vehicle part including a first connecting segment and a second connecting segment,
a first hose connector repairing element including a first section having a chamber formed in said first section for engaging with said first connecting segment of said vehicle part, and said first hose connector repairing element including a second section for engaging with said first hose member, said second section of said first hose connector repairing element including a compartment formed in said second section of said first hose connector repairing element,
a first tubular member engaged into said compartment of said second section of said first hose connector repairing element for reinforcing said second section of said first hose connector repairing element,
a second hose connector repairing element including a first section having a chamber formed in said first section of said second hose connector repairing element for engaging with said second connecting segment of said vehicle part, and said second hose connector repairing element including a second section for engaging with said second hose member, said second section of said second hose connector repairing element including a compartment formed in said second section of said second hose connector repairing element, and
a second tubular member engaged into said compartment of said second section of said second hose connector repairing element for reinforcing said second section of said second hose connector repairing element.

2. The hose connector repairing device as claimed in claim 1, wherein said first section of said first hose connector repairing element includes an outer diameter no less than that of said second section of said first hose connector repairing element, and said chamber of said first section of said first hose connector repairing element is communicating with said compartment of said second section of said first hose connector repairing element.

3. The hose connector repairing device as claimed in claim 1, wherein said first section of said second hose connector repairing element includes an outer diameter no less than that of said second section of said second hose connector repairing element, and said chamber of said first section of said second hose connector repairing element is communicating with said compartment of said second section of said second hose connector repairing element.

4. The hose connector repairing device as claimed in claim 1, wherein said first and said second connecting segments of said vehicle part are made of relatively harder materials, and said first sections of said first and said second hose connector repairing elements are made of relatively softer materials.

5. The hose connector repairing device as claimed in claim 1, wherein said first and said second tubular members are made of relatively harder materials, and said first and said second hose members are made of relatively softer materials.
